(19) United States
(12) Patent Application Publication
(10) Pub. No.: US 2024/0023093 A1
(43) Pub. Date: Jan. 18, 2024

(54) ULCI ENHANCEMENT FOR REDUCED CAPABILITY UE

(71) Applicant: QUALCOMM Incorporated, San Diego, CA (US)

(72) Inventors: Jing LEI, San Diego, CA (US); Wei YANG, San Diego, CA (US); Chao WEI, Beijing (CN); Peter GAAL, San Diego, CA (US)

(21) Appl. No.: 18/252,165

(22) PCT Filed: Jan. 25, 2021
(86) PCT No.: PCT/CN2021/073529

§ 371 Date: May 8, 2023

(51) Int. Cl. H04W 72/1268; H04W 72/53; H04W 72/232; H04L 5/14

(52) U.S. Cl. CPC H04W 72/1268; H04W 72/53; H04W 72/232; H04L 5/14

(57) ABSTRACT

Certain aspects of the present disclosure provide techniques for enhancements made to uplink cancellation indications (ULCIs) for specific user equipment (UE) types (e.g., a reduced capability (RedCap) UE). An example method by a user UE generally includes receiving an UL CI indicating resources on which one or more uplink transmissions are to be modified by the UE, and processing the ULCI in accordance with a first set of one or more parameters for ULCI processing specific to UEs of a first type.

### BACKGROUND

### Field of the Disclosure

Aspects of the present disclosure relate to wireless communications, and more particularly, to techniques for enhancements made to uplink cancellation indication (ULCI) processing.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure may provide advantages, such as improved coverage enhancement for random access procedures.

Certain aspects provide a method for wireless communication by a user equipment (UE). The method generally includes receiving an uplink cancelation indication (ULCI) indicating resources on which one or more uplink transmissions are to be modified by the UE, and processing the ULCI in accordance with a first set of one or more parameters for ULCI processing specific to UEs of a first type.

Certain aspects provide a method for wireless communication by a network entity. The method generally includes transmitting, to a UE, an ULCI indicating resources on which one or more uplink transmissions are to be modified by the UE, in accordance with first set of one or more parameters for ULCI specific to UEs of a first type, and processing uplink transmissions in accordance with the ULCI.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example base station (BS) and user equipment (UE), in accordance with certain aspects of the present disclosure.

FIG. 3 illustrates an example of a frame format for a telecommunication system, in accordance with certain aspects of the present disclosure.

FIG. 4A is a diagram illustrating example functionality of reduced capability (RedCap) UEs, in accordance with certain aspects of the present disclosure.

FIG. 4B illustrates example UE use cases and corresponding design objectives.

FIGS. 5A-5C are example timelines illustrating uplink (UL) cancellation indication (CI) signaling.

FIG. 6 illustrates example operations for wireless communication by a UE, in accordance with certain aspects of the present disclosure.

FIG. 7 illustrates example operations for wireless communication by a network entity, in accordance with certain aspects of the present disclosure.

FIGS. 8A and 8B illustrate examples of ULCI signaling for time relaxation and/or extension for ULCI, in accordance with certain aspects of the present disclosure.

FIG. 9 illustrates a communications device that may include various components configured to perform operations for the techniques disclosed herein in accordance with aspects of the present disclosure.

FIG. 10 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for enhanced uplink cancellation indication (ULCI) processing. The enhancements provided herein may help support ULCI in systems that deploy reduced capability (RedCap) UEs.

For example, the techniques presented herein may allow a RedCap UE to process ULCI with a more relaxed (e.g., longer) timeline, relative to more stringent ULCI timelines supported by other types of UEs. As will be described in greater detail below, the techniques may also allow for expanded time spans for applying ULCI and more flexibility in the type of UL transmissions to which ULCI is applied.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (SGTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

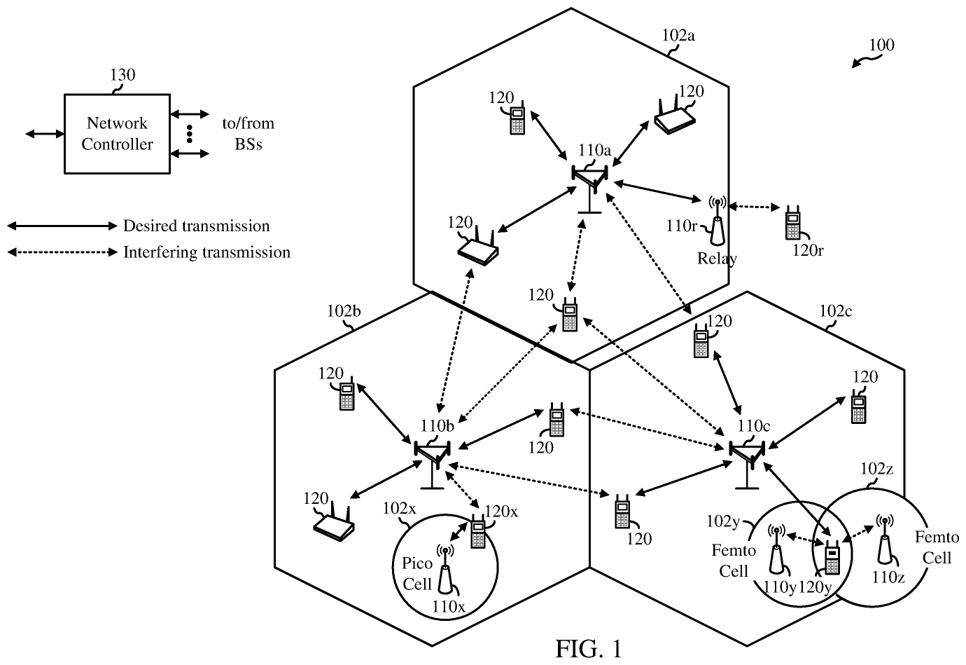

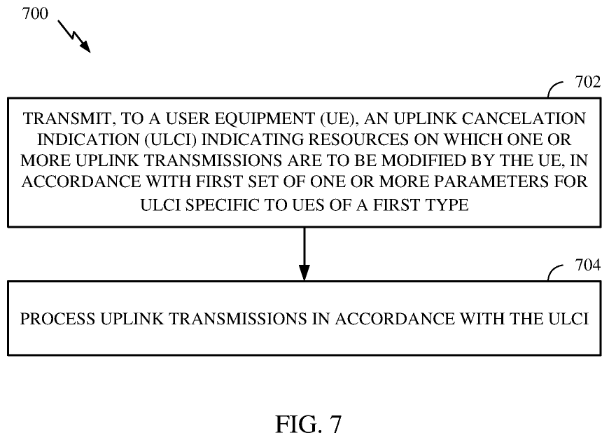

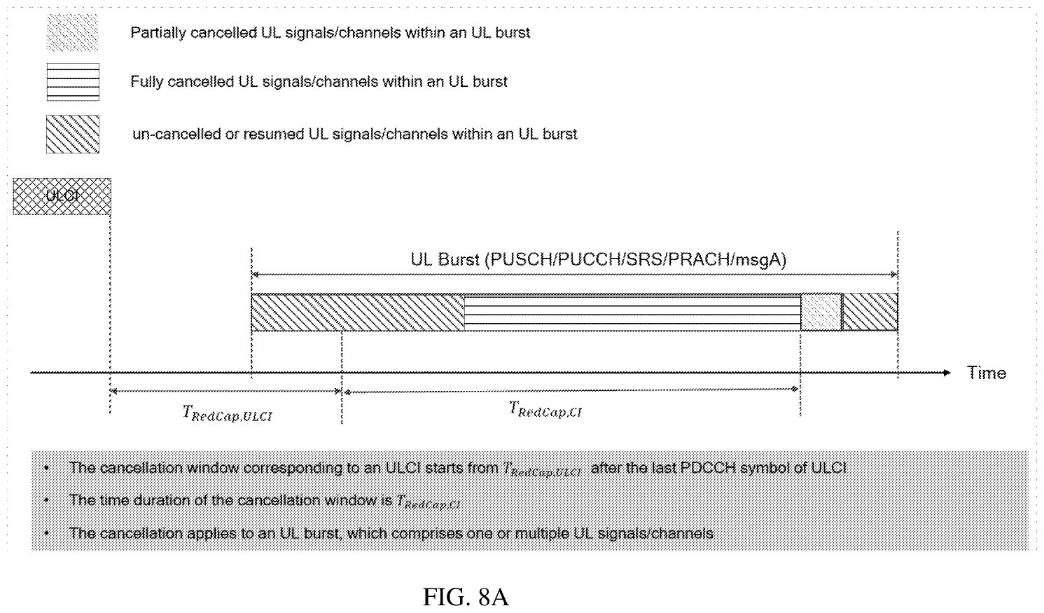

FIG. 1 illustrates an example wireless communication network 100 in which aspects of the present disclosure may be performed. For example, a UE 120 may be configured to perform operations 600 of FIG. 6 to process an uplink cancellation indication (ULCI) in accordance with parameters for ULCI processing, in accordance with various aspects discussed herein. Similarly, a base station 110 may be configured to perform operations 700 of FIG. 7 to signal an ULCI to a UE (e.g., the UE 120).

As illustrated in FIG. 1, the wireless communication network 100 may include a number of base stations (BS s) 110 and other network entities. As used herein, BS and network entity may be interchangeable terms when referring to a wireless communication entity. A BS may be a station that communicates with UEs. Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

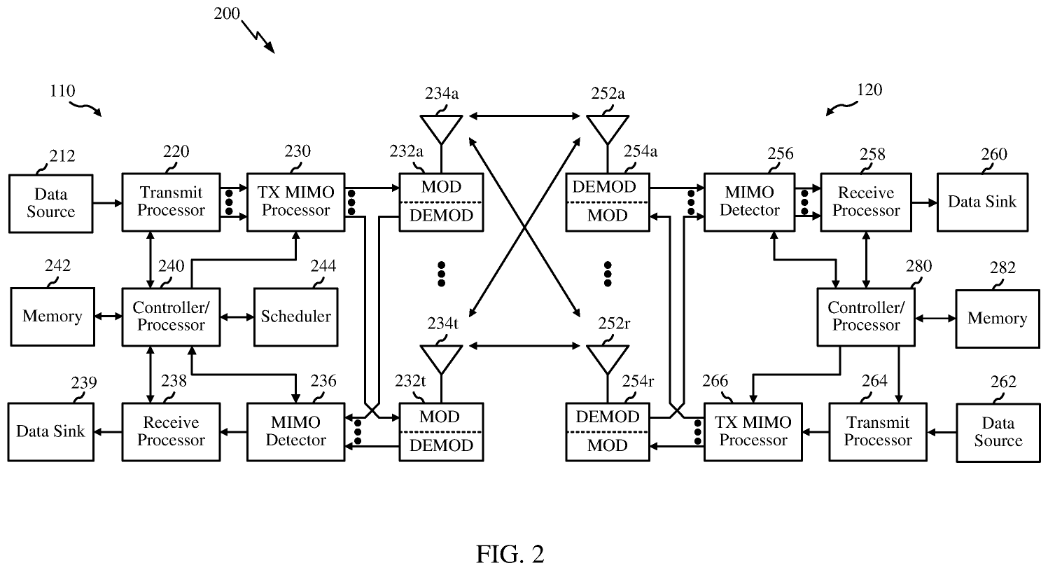

FIG. 2 illustrates example components of BS 110 and UE 120 (as depicted in FIG. 1), which may be used to implement aspects of the present disclosure. For example, antennas 252, processors 266, 258, 264, and/or controller/processor 280 of the UE 120 may be configured to perform the operations described with respect to FIG. 6, while similar processors of BS 110 may perform operations described with respect to FIG. 7.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The processor 220 may also generate reference symbols, e.g., for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 120, the antennas 252a through 252r may receive the downlink signals from the base station 110 and may provide received signals to the demodulators (DEMODs) in transceivers 254a through 254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a through 254r (e.g., for SC-FDM, etc.), and transmitted to the base station 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The controllers/processors 240 and 280 may direct the operation at the BS 110 and the UE 120, respectively. The processor 240 and/or other processors and modules at the BS 110 may perform or direct the execution of processes for the techniques described herein. The memories 242 and 282 may store data and program codes for BS 110 and UE 120, respectively. A scheduler 244 may schedule UEs for data transmission on the downlink and/or uplink.

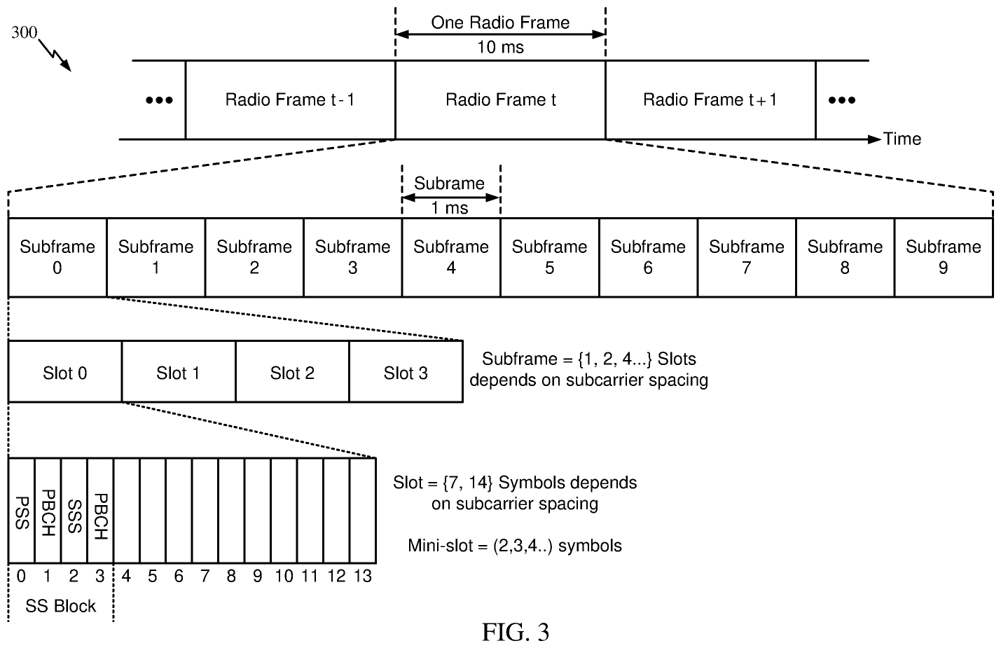

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIB s), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Reduced Capability (RedCap) UE

Various technologies may be the focus of current wireless communication standards. For example, Rel-15 and/or Rel-16 may focus on premium smartphones (e.g., enhanced mobile broadband (eMBB)), and other verticals such as ultra-reliable low latency communication (URLLC) and/or vehicle-to-everything (V2X) communications. In some wireless communication standards (e.g., Rel-17 and beyond) there may exist a strong desire for new radio (NR) to be scalable and deployable in a more efficient and cost-effective way. Thus, a new UE type with reduced capabilities (RedCap) has been introduced. In particular, a RedCap UE may exhibit a general relaxation of peak throughput, as well as lower latency and/or reliability requirements. For example, a RedCap UE may have a lower the device cost and complexity as compared to higher-end eMBB and/or URLLC devices of Rel-15 and/or Rel-16, especially for the use case of industrial sensors. For many use cases, a RedCap UE may be implemented with a device design having a more compact form factor. RedCap UEs may also support frequency range (FR) 1 and/or 2 bands for frequency division duplexed (FDD) and/or time division duplexed (TDD) communications.

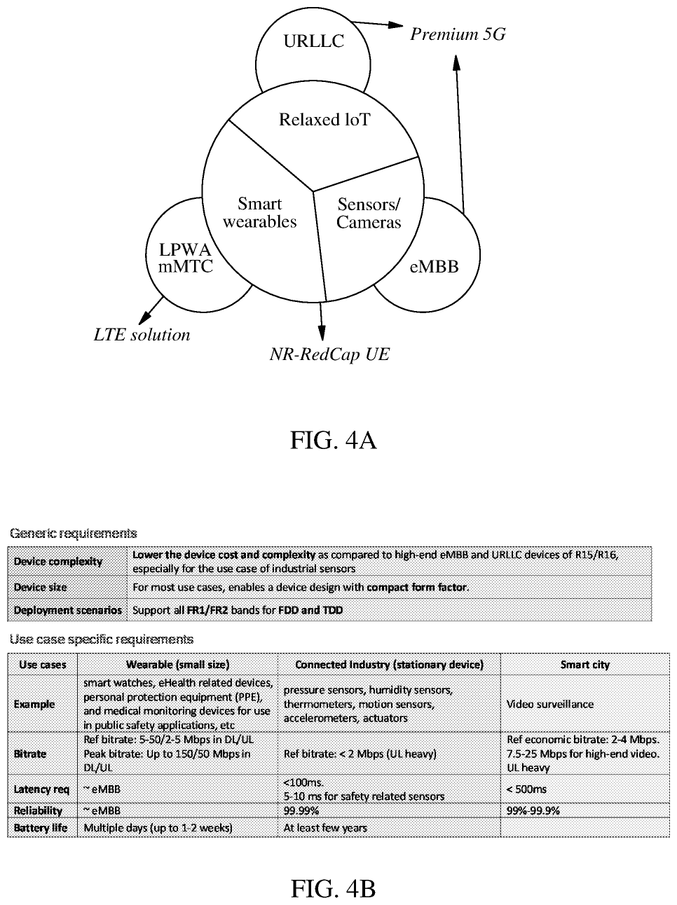

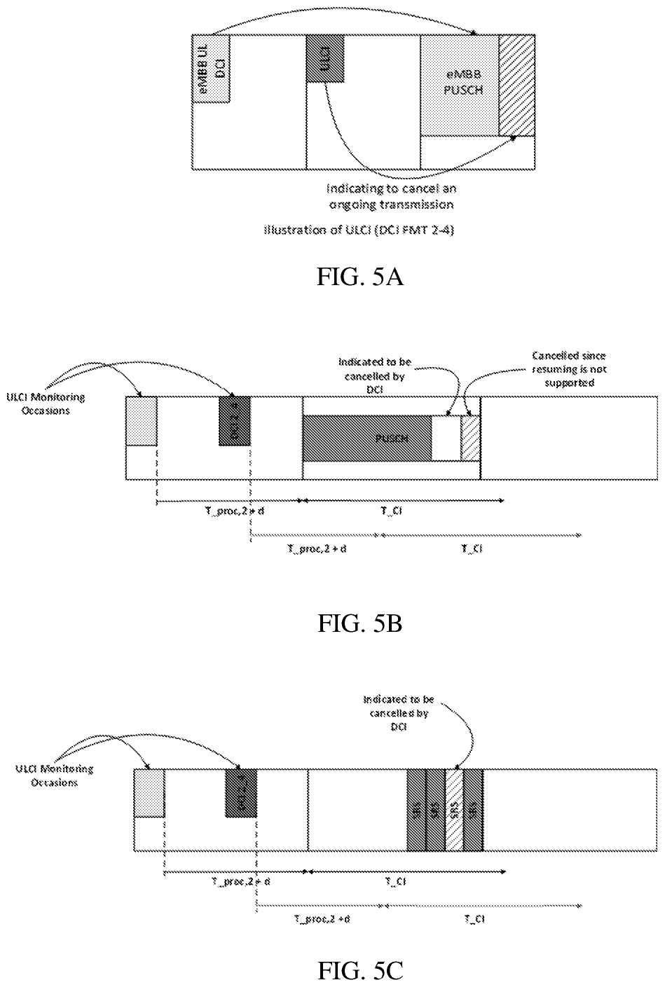

Thus, some design objectives of the NR RedCap UE may include scalable resource allocation, coverage enhancement for DL and/or UL, power saving in all RRC states, and/or co-existence with the NR premium UE. As shown in FIGS. 4A and 4B, an NR-RedCap UE may be a smart wearable device, a sensor/camera, or any other device configured for relaxed internet-of-things (IoT) communications. Additionally, based on the use case of a RedCap UE, various bitrates, latencies, reliability levels, and battery life may apply. Further, a RedCap UE functionality and/or capability may overlap with those of long term evolution (LTE) and/or fifth generation (5G) devices (e.g., premium 5G devices). For example, the functionality of relaxed IoT devices may overlap with that of URLLC devices, the functionality of smart wearable devices may overlap with that of low power wide area (LPWA) massive machine type communication (mMTC) devices, and/or the functionality of sensors/cameras may overlap with that of eMBB devices.

### Example ULCI Enhancement for RedCap UE

Aspects of the present disclosure relate to wireless communications, and more particularly, to techniques for enhanced uplink cancellation indication (ULCI) processing, for example, to support reduced capability (RedCap) UEs.

Uplink cancellation allows a network to prioritize certain types of traffic over other types of traffic. A network may signal a UE to cancel a portion of an already-scheduled lower priority uplink transmission to avoid interference to a higher priority uplink transmission (e.g., from another UE).

For example, when a network entity allocates resources scheduled for enhanced mobile broadband (eMBB) transmissions to an ultra-reliable low latency communication (URLLC) UE (e.g., due to latency requirements), the network entity may transmit an ULCI to the eMBB UEs to ask those UEs to stop their transmissions. When the UE detects the ULCI from the network entity, the UE thus stops the transmission (without resuming the transmission).

In conventional systems, ULCI is typically applicable to physical uplink shared channel (PUSCH) and sounding reference signal (SRS) transmissions. As in the example noted above, ULCI is implemented with the purpose of improving URLLC UE performance.

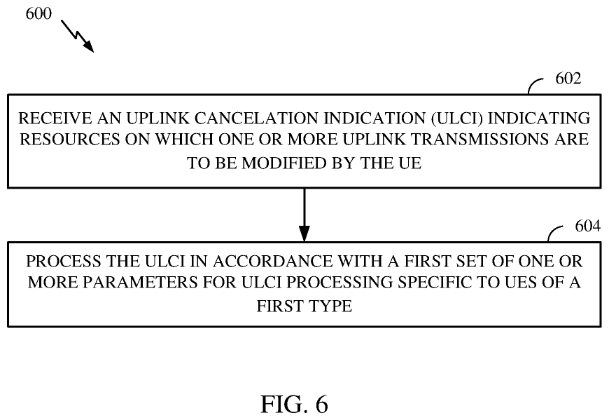

As illustrated in FIG. 5A, the network may schedule a UE with uplink resources for an eMBB PUSCH transmission. To accommodate URLLC traffic, for example, the network may send the UE an ULCI indicating the UE is to suspend the scheduled (e.g., ongoing/future) (eMBB) PUSCH or SRS.

As illustrated in FIG. 5B and FIG. 5C, ULCI may be applied within a cancellation window (T_{Cl}) that starts a T_{proc,2}+d from the end of the physical downlink control channel (PDCCH) reception (e.g., downlink control information (DCI)), where T_{proc,2} represents a minimum processing time for UE capability 2 (Cap #2) and d is reported as a UE capability and takes on a value of 0, 1, or 2. The minimum processing time for Cap #2 may be assumed even for Cap #1 UEs. The frequency span of the ULCI may be determined by variables, such as a Point A reference point, OffsetToCarrier, RB start (per UE per carrier), and/or RB length (per UE per carrier).

In the example shown in FIG. 5B, the ULCI results in cancellation of a portion of PUSCH. In some cases, even if resources are available after resources indicated via the ULCI, PUSCH resuming may not be supported In the example shown in FIG. 5C, the ULCI results in cancellation of one or more SRS transmissions.

In some systems (e.g., Rel-17 and beyond), RedCap UEs may be expected to support use cases with different quality of service (QoS) requirements. Further, some RedCap UEs (e.g., safety-related sensors) may have more stringent latency/reliability requirements than other implementations of RedCap UEs. Some Rel-17 RedCap UEs may not even support capabilities (e.g., Cap #2) of Rel-16 ULCI. Additionally, coverage enhancement for Rel-17 (and beyond) RedCap UE is expected to lead to more UL resources being occupied, which potentially increases the probability of scheduling conflict with non-RedCap UEs. Thus, it may be useful to introduce inter-UE priority handling among RedCap UEs to prioritize the use cases of lower latency and higher reliability.

Accordingly, certain aspects provide techniques for improved ULCI processing performed in a UE type-specific manner. For example, certain aspects are directed toward ULCI monitoring and processing by a UE (e.g., a RedCap UE) with a more relaxed timeline (e.g., compared to Cap #2). Additionally, in certain aspects, since inter-slot repetition is supported for Rel-17 UL coverage enhancement, and the repetition may not be continuous in time domain (e.g., interrupted by non-UL slots/symbols), the time span may be extended to apply ULCI across multiple repetitions.

FIG. 6 illustrates example operations 600 for wireless communication, in accordance with certain aspects of the present disclosure. The operations 600 may be performed, for example, by a UE (e.g., such as a UE 120a in the wireless communication network 100) to process an ULCI in accordance with parameters for ULCI processing.

Operations 600 begin, at 602, by receiving an ULCI indicating resources on which one or more uplink transmissions are to be modified by the UE.

At 604, the UE processes the ULCI in accordance with a first set of one or more parameters for ULCI processing specific to UEs of a first type.

FIG. 7 illustrates example operations 700 for wireless communication by a network entity and may be considered complementary to operations 700 of FIG. 7. For example, operations 700 may be performed by a BS 110 to signal ULCI to a UE performing operations 700 of FIG. 7.

Operations 700 begin, at 702, by transmitting, to a UE, a ULCI indicating resources on which one or more uplink transmissions are to be modified by the UE, in accordance with first set of one or more parameters for ULCI specific to UEs of a first type.

At 704, the network entity processes uplink transmissions in accordance with the ULCI.

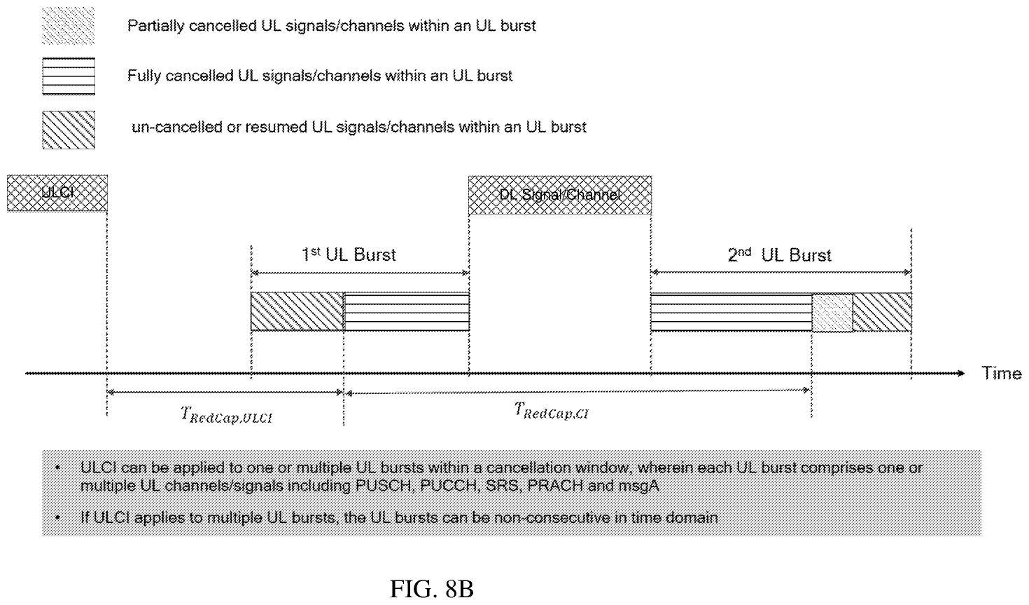

In some cases, ULCI monitoring and processing by the UE may be accomplished with a more relaxed timeline (e.g., compared to Cap #2). For example, as shown in FIG. 8A, if the network entity decides to cancel the UL transmission of a RedCap UE, the cancellation window corresponding to a ULCI may begin a time of T_{RedCap, ULCI} (e.g., a number of slots) from the last symbol of the PDCCH carrying DCI conveying the ULCI. In certain aspects, the T_{RedCap, ULCI} may be a processing time that is larger than the processing time T_{Proc, 2+d} of FIGS. 5B-5C. The time duration of the cancellation window may be T_{RedCap, CI}. The cancellation may apply to an uplink burst, which may include one or multiple uplink signals/channels.

In some cases, the T_{Redcap, ULCI} may be configured for the UE at a slot level by system information (SI) dedicated to the UE, radio resource control (RRC) signaling semi-statically configured for the UE, RRC configuration information for an active UL bandwidth part (BWP) of the UE, a sub-field of DCI conveying the ULCI, and/or a combination of look up table (e.g., defined in a standard or conveyed via RRC signaling) and UE capability signaling.

In certain aspects, the time span of UL resources that can be canceled by ULCI may be extended. For example, as illustrated in FIG. 8B, since inter-slot repetition may not be continuous in time domain (e.g., resources allocated to “U U D F U U”, where the repetition on UL is interrupted by DL/flexible symbol/slot), the time span T_{RedCap, CI} for the UL resources that can be canceled may be extended such that cancellation occurs in all of the UL repetition resources. As shown, the ULCI can be applied to one or multiple uplink bursts within the cancellation window, wherein each uplink burst may include one or multiple uplink channels/signals (e.g., including PUSCH, PUCCH, SRS, PRACH and msgA). If ULCI applies to multiple UL bursts, the UL bursts can be non-consecutive in time domain.

In some cases, the time span configuration can be UE-specific or group-common. In specifying the time span for ULCI, the various options can be considered. For example, the starting slot/symbol (S) and the length of slots/symbols (L) can be encoded by a starting and length indicator vector (SLIV), where the values of S and L count the UL resources only. As another example, the set of UL slots/symbols can be sequentially divided into multiple groups, where each group includes the same number of UL slots/symbols.

As described above, in conventional systems, ULCI may be applicable to only PUSCH and SRS. However, certain aspects provide for expanding the application of ULCI to include PUSCH, SRS, PUCCH, and/or physical random access channel (PRACH).

Furthermore, additional conditions may be implemented by the UE to determine whether to cancel certain UL resources (e.g., for PUCCH and/or PRACH). For example, the UE may determine that the ULCI is applicable to PUCCH carrying a P-CSI report only. As another example, the UE may determine that the ULCI is applicable to PRACH transmitted in an RRC connected state for 4-step RACH procedure or 2-step RACH procedure.

In some cases, the network entity can provide assistance information for the priority of ULCI. This case be accomplished, for example, by an explicit indication in the ULCI, and/or an implicit indication by a cancellation indication radio network temporary identifier (CI-RNTI) mapping, a common search space (CSS) configuration, and/or demodulation reference signal (DMRS) scrambling. A UE receiving this assistance information, in any form, may perform ULCI accordingly (e.g., knowing what additional conditions to apply, what timing, and/or what uplink transmissions are subject to ULCI).

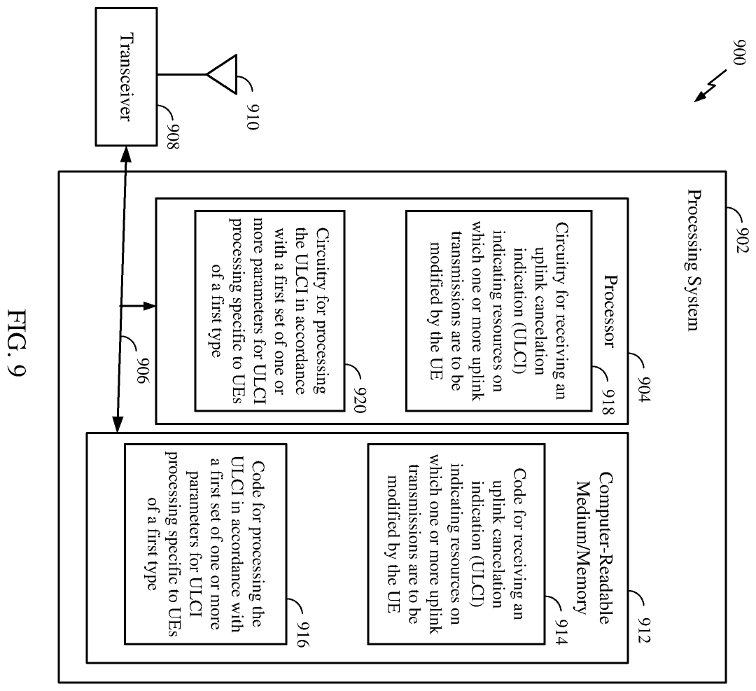

FIG. 9 illustrates a communications device 900 that may include various components (e.g., corresponding to means-plus-function components) configured to perform operations for the techniques disclosed herein, such as the operations illustrated in FIG. 6. The communications device 900 includes a processing system 902 coupled to a transceiver 908. The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes a processor 904 coupled to a computer-readable medium/memory 912 via a bus 906. In certain aspects, the computer-readable medium/memory 912 is configured to store instructions (e.g., computer-executable code) that when executed by the processor 904, cause the processor 904 to perform the operations illustrated in FIG. 6, or other operations for performing the various techniques discussed herein. In certain aspects, computer-readable medium/memory 912 stores code 914 for receiving an ULCI indicating resources on which one or more uplink transmissions are to be modified by the UE; and code 916 for processing the ULCI in accordance with a first set of one or more parameters for ULCI processing specific to UEs of a first type. In certain aspects, the processor 904 has circuitry configured to implement the code stored in the computer-readable medium/memory 912. The processor 904 includes circuitry 918 for receiving an ULCI indicating resources on which one or more uplink transmissions are to be modified by the UE; and circuitry 920 for processing the ULCI in accordance with a first set of one or more parameters for ULCI processing specific to UEs of a first type.

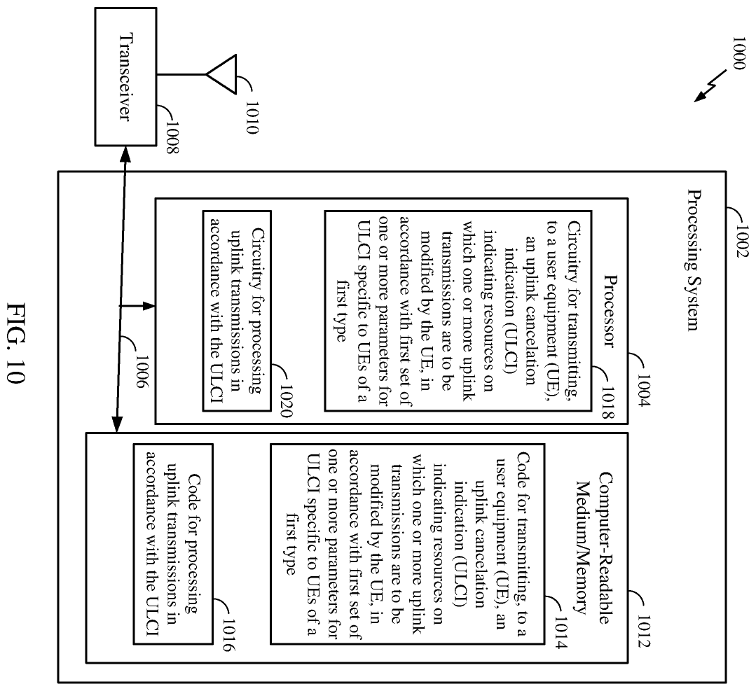

FIG. 10 illustrates a communications device 1000 that may include various components (e.g., corresponding to means-plus-function components) configured to perform operations for the techniques disclosed herein, such as the operations illustrated in FIG. 7. The communications device 1000 includes a processing system 1002 coupled to a transceiver 1008. The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 7, or other operations for performing the various techniques discussed herein. In certain aspects, computer-readable medium/memory 1012 stores code 1014 for transmitting, to a UE, an ULCI indicating resources on which one or more uplink transmissions are to be modified by the UE, in accordance with first set of one or more parameters for ULCI specific to UEs of a first type; and code 1016 for processing uplink transmissions in accordance with the ULCI. In certain aspects, the processor 1004 has circuitry configured to implement the code stored in the computer-readable medium/memory 1012. The processor 1004 includes circuitry 1018 for transmitting, to a UE, an ULCI indicating resources on which one or more uplink transmissions are to be modified by the UE, in accordance with first set of one or more parameters for ULCI specific to UEs of a first type; and circuitry 1020 for processing uplink transmissions in accordance with the ULCI.

### Example Aspects

Aspect 1: A method for wireless communication by a user equipment (UE), comprising receiving an uplink cancelation indication (ULCI) indicating resources on which one or more uplink transmissions are to be modified by the UE; and processing the ULCI in accordance with a first set of one or more parameters for ULCI processing specific to UEs of a first type.

Aspect 2: The method of Aspect 1, wherein UEs of the first type comprise reduced capability (RedCap) UEs that support a minimum processing time that is greater than a minimum processing time supported by UEs of a second type.

Aspect 3: The method of Aspect 1 or 2, wherein the first set of one or more parameters comprise at least one timing parameter that defines a window in which the ULCI is applied.

Aspect 4: The method of Aspect 3, wherein the timing parameter indicates the window in which the ULCI is applied begins a number of slots after an end of physical downlink control channel (PDCCH) carrying a downlink control information (DCI) conveying the ULCI.

Aspect 5: The method of Aspect 3 or 4, wherein the timing parameter is indicated via at least one of system information (SI) dedicated to UEs of the first type; radio resource control (RRC) signaling semi-statically configured for UEs of the first type; or RRC configuration information for an active uplink bandwidth part (UL BWP) of UEs of the first type.

Aspect 6: The method of any of Aspects 3-5, wherein the timing parameter is conveyed via a sub-field of a downlink control information conveying the ULCI.

Aspect 7: The method of any of Aspects 3-6, wherein the timing parameter is determined via a combination of a look up table and UE capability signaling.

Aspect 8: The method of any of Aspects 1-7, wherein the first set of one or more parameters comprise at least one timing parameter that defines a time span of uplink resources to which the ULCI can be applied.

Aspect 9: The method of Aspect 8, wherein the time span includes consecutive and non-consecutive uplink symbols or slots within a frame for time division duplexed (TDD) and half duplex frequency division duplexed (HD-FDD) operation.

Aspect 10: The method of Aspect 8 or 9, wherein the time span is determined based on a starting slot or symbol and a length of slots or symbols.

Aspect 11: The method of Aspect 10, wherein the starting slot or symbol are encoded in a starting and length indicator vector (SLIV) and account for uplink resources only.

Aspect 12: The method of any of Aspects 8-11, wherein the time span spans a set of UL slots or symbols sequentially divided into multiple groups, where each group includes the same number of uplink slots or symbols.

Aspect 13: The method of any of Aspects 1-12, wherein processing the ULCI comprises applying the ULCI to at least one of: physical uplink control channel (PUCCH) or physical random access channel (PRACH) transmissions.

Aspect 14: The method of Aspect 13, wherein the ULCI is applied to PUCCH or PRACH transmission if one or more conditions are met.

Aspect 15: The method of Aspect 14, wherein the one or more conditions comprise the PUCCH carries a channel state information (CSI) report only.

Aspect 16: The method of Aspect 14 or 15, wherein the one or more conditions comprise the PRACH is transmitted while the UE is in a radio resource control (RRC) connected state for a 4-step RACH or 2-step RACH procedure.

Aspect 17: The method of any of Aspects 1-16, further comprising receiving signaling indicating a priority of applying the ULCI.

Aspect 18: The method of Aspect 17, wherein the signaling comprises at least one of an explicit indication in the ULCI, an implicit indication by a radio network temporary identifier (RNTI) mapping, a common search space (CSS) configuration, or a demodulation reference signal (DMRS) scrambling.

Aspect 19: A method for wireless communication by a network entity, comprising transmitting, to a UE, an ULCI indicating resources on which one or more uplink transmissions are to be modified by the UE, in accordance with first set of one or more parameters for ULCI specific to UEs of a first type; and processing uplink transmissions in accordance with the ULCI.

Aspect 20: The method of Aspect 19, wherein UEs of the first type comprise RedCap UEs that support a minimum processing time that is greater than a minimum processing time supported by UEs of a second type.

Aspect 21: The method of Aspect 19 or 20, wherein the first set of one or more parameters comprise at least one timing parameter that defines a window in which the ULCI is applied.

Aspect 22: The method of Aspect 21, wherein the timing parameter indicates the window in which the ULCI is applied begins a number of slots after an end of a PDCCH carrying DCI conveying the ULCI.

Aspect 23: The method of Aspect 21 or 22, wherein the timing parameter is indicated via at least one of SI dedicated to UEs of the first type; RRC signaling semi-statically configured for UEs of the first type; or RRC configuration information for an active UL BWP of UEs of the first type.

Aspect 24: The method of any of Aspects 21-23, wherein the timing parameter is conveyed via a sub-field of a downlink control information conveying the ULCI.

Aspect 25: The method of any of Aspects 21-24, wherein the timing parameter is based on a combination of a look up table and UE capability signaling.

Aspect 26: The method of any of Aspects 19-25, wherein the first set of one or more parameters comprise at least one timing parameter that defines a time span of uplink resources to which the ULCI can be applied.

Aspect 27: The method of Aspect 26, wherein the time span includes consecutive and non-consecutive uplink symbols or slots within a frame for TDD and HD-FDD operation.

Aspect 28: The method of Aspect 26 or 27, wherein the time span is determined based on a starting slot or symbol and a length of slots or symbols.

Aspect 29: The method of Aspect 28, wherein the starting slot or symbol are encoded in a SLIV and account for uplink resources only.

Aspect 30: The method of any of Aspects 26-29, wherein the time span spans a set of UL slots or symbols sequentially divided into multiple groups, where each group includes the same number of uplink slots or symbols.

Aspect 31: The method of any of Aspects 19-30, wherein processing the ULCI comprises applying the ULCI to at least one of PUCCH or PRACH transmissions.

Aspect 32: The method of Aspect 31, wherein the ULCI is applied to PUCCH or PRACH transmission if one or more conditions are met.

Aspect 33: The method of Aspect 32, wherein the one or more conditions comprise the PUCCH carries a CSI report only.

Aspect 34: The method of Aspect 32 or 33, wherein the one or more conditions comprise the PRACH is transmitted while the UE is in a RRC connected state for a 4-step RACH or 2-step RACH procedure.

Aspect 35: The method of any of Aspects 19-34, further comprising transmitting an indication of a priority of applying the ULCI.

Aspect 36: The method of Aspect 35, wherein the indication comprises at least one of an explicit indication in the ULCI, an implicit indication by a RNTI mapping, a CSS configuration, or a DMRS scrambling.

Aspect 37: An apparatus for wireless communication, comprising a memory and at least one processor coupled to the memory, the memory and the at least one processor being configured to perform any of the operations of Aspects 1-36.

Aspect 38: An apparatus for wireless communication by a UE, comprising means for performing any of the operations of Aspects 1-36.

Aspect 39: A computer readable medium having instructions stored thereon for performing any of the operations of Aspects 1-36.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, and/or 5G wireless technologies, aspects of the present disclosure can be applied in other generation-based communication systems.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations and techniques described herein and illustrated in FIGS. 6-10.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method for wireless communication by a user equipment (UE), comprising:
receiving an uplink cancelation indication (ULCI) indicating resources on which one or more uplink transmissions are to be modified by the UE; and
processing the ULCI in accordance with a first set of one or more parameters for ULCI processing specific to UEs of a first type.

2. The method of claim 1, wherein:
UEs of the first type comprise reduced capability (RedCap) UEs that support a minimum processing time that is greater than a minimum processing time supported by UEs of a second type.

3. The method of claim 1, wherein the first set of one or more parameters comprise at least one timing parameter that defines a window in which the ULCI is applied.

4. The method of claim 3, wherein the timing parameter indicates the window in which the ULCI is applied begins a number of slots after an end of physical downlink control channel (PDCCH) carrying a downlink control information (DCI) conveying the ULCI.

5. The method of claim 3, wherein the timing parameter is indicated via at least one of:
system information (SI) dedicated to UEs of the first type;
radio resource control (RRC) signaling semi-statically configured for UEs of the first type;
a medium access control (MAC) layer's control element (CE);
or
RRC configuration information for an active uplink bandwidth part (UL BWP) of UEs of the first type.

6. The method of claim 3, wherein the timing parameter is conveyed via a sub-field of a downlink control information conveying the ULCI.

7. The method of claim 3, wherein the timing parameter is determined via a combination of a look up table and UE capability signaling.

8. The method of claim 1, wherein the first set of one or more parameters comprise at least one timing parameter that defines a time span of uplink resources to which the ULCI can be applied.

9. The method of claim 8, wherein the time span includes one or multiple uplink bursts consecutive or non-consecutive in time, wherein each uplink burst comprises a plural of uplink symbols or slots within a frame for time division duplexed (TDD), full duplex frequency division duplexed (FD-FDD), and half duplex frequency division duplexed (HD-FDD) operation.

10. The method of claim 8, wherein the time span is determined based on a starting slot or symbol and a length of slots or symbols.

11. The method of claim 10, wherein the starting slot or symbol are encoded in a starting and length indicator vector (SLIV) and account for uplink resources only.

12. The method of claim 8, wherein the time span spans a set of UL slots or symbols sequentially divided into multiple groups, where each group includes the same number of uplink slots or symbols.

13. The method of claim 1, wherein processing the ULCI comprises applying the ULCI to at least one of: physical uplink control channel (PUCCH) or physical random access channel (PRACH) or random access message of 2-step RACH (msgA) transmissions.

14. The method of claim 13, wherein the ULCI is applied to PUCCH or PRACH transmission if one or more conditions are met.

15. The method of claim 14, wherein the one or more conditions comprise:
the PUCCH carries a channel state information (CSI) report only.

16. The method of claim 14, wherein the one or more conditions comprise:
the PRACH is transmitted while the UE is in a radio resource control (RRC) connected state for a 4-step RACH or 2-step RACH procedure.

17. The method of claim 1, further comprising receiving signaling indicating a priority of applying the ULCI.

18. The method of claim 17, wherein the signaling comprises at least one of:
an explicit indication in the ULCI, an implicit indication by a radio network temporary identifier (RNTI) mapping, a common search space (CSS) configuration, or a demodulation reference signal (DMRS) scrambling.

19. A method for wireless communication by a network entity, comprising:
transmitting, to a user equipment (UE), an uplink cancelation indication (ULCI) indicating resources on which one or more uplink transmissions are to be modified by the UE, in accordance with first set of one or more parameters for ULCI specific to UEs of a first type; and
processing uplink transmissions in accordance with the ULCI.

20. The method of claim 19, wherein:
UEs of the first type comprise reduced capability (RedCap) UEs that support a minimum processing time that is greater than a minimum processing time supported by UEs of a second type.

21. The method of claim 19, wherein the first set of one or more parameters comprise at least one timing parameter that defines a window in which the ULCI is applied.

22. The method of claim 21, wherein the timing parameter indicates the window in which the ULCI is applied begins a number of slots after an end of a physical downlink control channel (PDCCH) carrying downlink control information (DCI) conveying the ULCI.

23. The method of claim 21, wherein the timing parameter is indicated via at least one of:
system information (SI) dedicated to UEs of the first type;
radio resource control (RRC) signaling semi-statically configured for UEs of the first type; or
RRC configuration information for an active uplink bandwidth part (UL BWP) of UEs of the first type.

24. The method of claim 21, wherein the timing parameter is conveyed via a sub-field of a downlink control information conveying the ULCI.

25. The method of claim 21, wherein the timing parameter is based on a combination of a look up table and UE capability signaling.

26. The method of claim 19, wherein the first set of one or more parameters comprise at least one timing parameter that defines a time span of uplink resources to which the ULCI can be applied.

27. The method of claim 26, wherein the time span includes consecutive and non-consecutive uplink symbols or slots within a frame for time division duplexed (TDD), full duplex frequency division duplexed (FD-FDD), and half duplex frequency division duplexed (HD-FDD) operation.

28. The method of claim 26, wherein the time span is determined based on a starting slot or symbol and a length of slots or symbols.

29. The method of claim 28, wherein the starting slot or symbol are encoded in a starting and length indicator vector (SLIV) and account for uplink resources only.

30. The method of claim 26, wherein the time span spans a set of UL slots or symbols sequentially divided into multiple groups, where each group includes the same number of uplink slots or symbols.

31. The method of claim 19, wherein processing the ULCI comprises applying the ULCI to at least one of: physical uplink control channel (PUCCH) or physical random access channel (PRACH) transmissions.

32. The method of claim 31, wherein the ULCI is applied to PUCCH or PRACH transmission if one or more conditions are met.

33. The method of claim 32, wherein the one or more conditions comprise:
the PUCCH carries a channel state information (CSI) report only.

34. The method of claim 32, wherein the one or more conditions comprise:
the PRACH is transmitted while the UE is in a radio resource control (RRC) connected state for a 4-step RACH or 2-step RACH procedure.

35. The method of claim 19, further comprising transmitting an indication of a priority of applying the ULCI.

36. The method of claim 35, wherein the indication comprises at least one of:
an explicit indication in the ULCI, an implicit indication by a radio network temporary identifier (RNTI) mapping, a common search space (CSS) configuration, or a demodulation reference signal (DMRS) scrambling.
